(19) United States
(12) Patent Application Publication
(10) Pub. No.: US 2012/0142838 A1
(43) Pub. Date: Jun. 7, 2012

(54) METHOD FOR IMPROVING THE STORAGE STABILITY OF AQUEOUS COMPOSITE-PARTICLE DISPERSIONS

(75) Inventor: Bas Lohmeijer, Mannheim (DE)

(73) Assignee: BASF SE, Ludwigshafen (DE)

(21) Appl. No.: 13/375,934

(22) PCT Filed: Jun. 1, 2010
(86) PCT No.: PCT/EP10/57608

§ 371 Date: Dec. 2, 2011

(30) Foreign Application Priority Data
Jun. 3, 2009 (EP) 09161827.2

(51) Int. Cl. C08K 13/02; C08L 43/04

(52) U.S. Cl. 524/265; 524/730; 524/731

(57) ABSTRACT

The invention provides a process for improving the storage stability of aqueous composite-particle dispersions and of aqueous formulations comprising them.

The present invention relates to a process for improving the storage stability of an aqueous dispersion of particles composed of addition polymer and finely divided inorganic solid (composite particles), wherein, before, during and/or after the preparation of the composite particles dispersed in the aqueous medium (composite-particle dispersion), an organic silane compound I, of the general formula

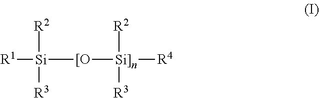

where
R¹ to R³ are —C₁-C₁₀ alkoxy,
   unsubstituted or substituted C₁-C₃₀ alkyl,
   unsubstituted or substituted C₅-C₁₅ cycloalkyl,
   unsubstituted or substituted C₆-C₁₀ aryl,
   unsubstituted or substituted C₇-C₁₂ aralkyl,
R⁴ is CH₂—[CHR⁵]_{φ}—[O—CH₂CH₂]ₓ—[O—CH₂—CH(CH₃)]_{y}—O—Z,
R⁵ is hydrogen or C₁-C₄ alkyl,
Z is hydrogen or C₁-C₄ alkyl,
n is an integer from 0 to 5,
φ is an integer from 0 to 5,
x is an integer from 1 to 30,
y is an integer from 0 to 30, and
   at least one of the radicals R¹ to R³ is C₁-C₁₀ alkoxy,
   is added to the aqueous dispersion medium.

The present invention likewise relates to aqueous composite-particle dispersions obtained by the process of the invention and also to aqueous formulations comprising such aqueous composite-particle dispersions.

Aqueous composite-particle dispersions are general knowledge. They are fluid systems whose disperse phase in the aqueous dispersion medium comprises polymer coils consisting of a plurality of intertwined polymer chains—known as the polymer matrix—and particles composed of finely divided inorganic solid, which are in disperse distribution. The diameter of the composite particles is frequently within the range from 10 nm to 5 000 nm.

Composite particles and processes for their preparation in the form of aqueous composite-particle dispersions, and also the use thereof, are known to the skilled worker and are disclosed for example in the publications U.S. Pat. No. 3,544,500, U.S. Pat. No. 4,421,660, U.S. Pat. No. 4,608,401, U.S. Pat. No. 4,981,882, EP-A 104 498, EP-A 505 230, EP-A 572 128, GB-A 2 227 739, WO 0118081, WO 0129106, WO 03000760 and also in Long et al., Tianjin Daxue Xuebao 1991, 4, pages 10 to 15, Bourgeat-Lami et al., Die Angewandte Makromolekulare Chemie 1996, 242, pages 105 to 122, Paulke et al., Synthesis Studies of Paramagnetic Polystyrene Latex Particles in Scientific and Clinical Applications of Magnetic Carriers, pages 69 to 76, Plenum Press, New York, 1997, Armes et al., Advanced Materials 1999, 11, No. 5, pages 408 to 410.

A disadvantage of the aqueous composite-particle dispersions or of aqueous formulations comprising them is that on prolonged storage, in particular at temperatures≧40° C., they may exhibit a viscosity increase which may even go as far as gelling. This may make it more difficult to process the aqueous composite-particle dispersions or aqueous formulations comprising them. In extreme cases the aqueous composite-particle dispersions or aqueous formulations comprising them may even become unusable for processing.

The starting point for the stabilization of aqueous composite-particle dispersions is the following prior art.

WO 05083015 thus discloses stabilizing aqueous composite-particle dispersions by addition of hydroxyl-containing alkylamino compounds.

The European patent application with the application No. 08155200.2, unpublished at the priority date of the present specification, proposes improving the storage stability of aqueous composite-particle dispersions by addition of a zwitterionic compound.

It was an object of the present invention to provide an alternative and more efficient process for improving the storage stability of aqueous composite-particle dispersions and of aqueous formulations comprising them.

Accordingly the processes defined at the outset were found.

In the context of the present specification, “before the preparation of the aqueous composite-particle dispersion” is intended to mean the addition of the silane compound

I at any desired point in time before the polymerization reaction is initiated; “during the preparation of the aqueous composite-particle dispersion” is intended to mean the addition of the silane compound I at any desired point in time during the polymerization reaction; and “after the preparation of the aqueous composite-particle dispersion” is intended to mean the addition of a silane compound I at any desired point in time after the conclusion of the polymerization reaction, the addition taking place to the aqueous dispersion medium. To the skilled worker here it is self-evident that an aqueous dispersion medium, after the end of the polymerization reaction, may still comprise small amounts (≦5%, advantageously ≦2%, and with particular advantage ≦1% by weight, based on the total monomer amount) of unreacted ethylenically unsaturated monomers, referred to as residual monomers.

It is of particular advantage for the process of the invention if the silane compound I is added to the aqueous dispersion medium of the aqueous composite-particle dispersion after the preparation of the aqueous composite-particle dispersion. It is obvious in this case that the signification of “after the preparation of the aqueous composite-particle dispersion” also includes the preparation of an aqueous formulation in whose preparation, besides other formulating ingredients, an aqueous composite-particle dispersion and, separately, at least one silane compound I is added.

The silane compound I may be metered into the aqueous medium before, during and/or after the preparation of the aqueous composite-particle dispersion, as a separate, individual stream or in a mixture with other components, discontinuously in one or more portions, or continuously with a constant or changing volume flow rate.

It is favorable if the aqueous composite-particle dispersion comprising at least one silane compound I, or an aqueous formulation comprising this dispersion, has a pH≧4, ≧5, ≧6 or ≧7 and ≦10, ≦11, ≦12 or ≦13. Advantageously a pH in the range of ≧7 and ≦11 is set. With particular advantage the aqueous composite-particle dispersion, even before a silane compound I is added, has a pH in the range of ≧7 and ≦11. In accordance with the invention the pH levels are measured at 20 to 25° C. (room temperature) with a calibrated pH meter.

In the organic silane compound of the general formula (I), the substituents R¹ to R³ are:
C₁-C₁₀ alkoxy, in particular methoxy, ethoxy, n-propoxy or isopropoxy, n-butoxy, tert-butoxy, and with particular advantage methoxy and ethoxy,
unsubstituted or substituted C₁-C₃₀ alkyl, but in particular unsubstituted alkyl, such as methyl, ethyl, n-propyl, isopropyl, n-butyl, isobutyl, tert-butyl, n-pentyl, n-octyl, n-decyl, n-hexadecyl and the isomers thereof, or substituted alkyl, substituted for example by one or more amino, acetoxy, benzoyl, halogen, cyano, glycidyloxy, hydroxy, isocyanate, mercapto, phenoxy, phosphate or isothiocyanato groups,
unsubstituted or substituted (for corresponding substitutents see C₁-C₃₀ alkyl) C₅-C₁₅ cycloalkyl, but in particular cyclopentyl or cyclohexyl,
unsubstituted or substituted (for corresponding substituents see C₁-C₃₀ alkyl) C₆-C₁₀ aryl, but in particular phenyl, halophenyl or chlorosulfonylphenyl, or
unsubstituted or substituted (for corresponding substituents see C₁-C₃₀ alkyl) C₇-C₁₂ aralkyl, but in particular benzyl,
   and at least one of the radicals R¹ to R³ is C₁-C₁₀ alkoxy. With advantage at least two of the radicals R¹ to R³, and with particular advantage all three radicals R¹ to R³, are C₁-C₁₀ alkoxy, with methoxy groups and/or ethoxy groups being particularly preferred. If only one or two of the radicals R¹ to R³ are C₁-C₁₀ alkoxy, then the remaining radicals are preferably C₁-C₁₀ alkyl.

Furthermore, in the organic silane compound I
R⁵ is hydrogen, C₁-C₄ alkyl, such as methyl, ethyl, n-propyl, isopropyl, n-butyl, isobutyl, tert-butyl, with hydrogen being particularly preferred,
Z is hydrogen, C₁-C₄ alkyl, as described for R⁵, with hydrogen or methyl being particularly preferred,
n is an integer from 0 to 5, preferably from 0 to 1, more preferably 0,
φ is an integer from 0 to 5, preferably from 1 to 3, more preferably 2,
x is an integer from 1 to 30, preferably from 3 to 20, and with particular preference from 6 to 15, and
y is an integer from 0 to 30, preferably from 0 to 10, and with particular preference from 0 to 5.

It is also important that in the substituent R⁴ the structural element —[O—CH₂CH₂]ₓ—[O—CH₂—CH(CH₃)]_{y}— stands not only for a block of x ethyleneoxy units and a block of y propyleneoxy units but also for a mixed polymer unit comprising x ethyleneoxy units and y propyleneoxy units. It is self evident to the skilled worker here that the propyleneoxy unit —[O—CH₂—CH(CH₃)]— also comprises its isomeric structure —[O—CH(CH₃)—CH₂]—.

Particularly preferred silane compounds I are those in which R¹ to R³ are methoxy or ethoxy, R⁵ is hydrogen, Z is hydrogen or methyl, n and y are the number 0, φ is the number 2, and x is a number≧3 and ≦20, where 3-[methoxy-{tri(ethyleneoxy)}]-propyltrimethoxysilane, 3-[methoxy{poly(ethyleneoxy)}]propyltrimethoxysilane with a degree of ethoxylation of 6 to 9, 3-[methoxy{poly(ethyleneoxy)}]propyltrimethoxysilane with a degree of ethoxylation of 9 to 12 and/or 3-[methoxy{poly(ethyleneoxy)}]propyl-trimethoxysilane with a degree of ethoxylation of 12 to 15 are particularly preferred.

In the process of the invention, the amount of the silane compound I is advantageously from 0.01 to 10% by weight, preferably from 0.05 to 5% by weight and more preferably from 0.1 to 2% by weight, based in each case on the total amount of the aqueous composite-particle dispersion. The total amount of the silane compound I can be added to the aqueous dispersion medium before the preparation of the composite particles. Additionally it is possible to add at least one portion of the silane compound Ito the aqueous medium before the preparation of the composite particles and to add the remaining portion to the aqueous medium during or after the preparation of the composite particles. With advantage, however, the entirety of the silane compound I is added to the aqueous composite-particle dispersion or to the aqueous formulation comprising it. It is, however, also possible to add a portion of the silane compound I to the aqueous composite-particle dispersion and to add the remaining portion of the silane compound I to the aqueous formulation comprising the aqueous composite-particle dispersion.

The process of the invention is advantageously suitable for aqueous composite-particle dispersions of the kind prepared by a procedure which is disclosed in WO 03000760 and to which express reference is made in the context of this specification. The features of that process are that at least one ethylenically unsaturated monomer is dispersely distributed in aqueous medium and is polymerized by the method of free-radical aqueous emulsion polymerization by means of at least one free-radical polymerization initiator in the presence of at least one dispersely distributed, finely divided inorganic solid and at least one dispersant, wherein
a) a stable aqueous dispersion of said at least one inorganic solid is used, said dispersion having the characteristic features that at an initial solids concentration of ≧1% by weight, based on the aqueous dispersion of said at least one inorganic solid, it still comprises in dispersed form one hour after its preparation more than 90% by weight of the originally dispersed solid and its dispersed solid particles have a weight-average diameter≦100 nm,
b) the dispersed particles of said at least one inorganic solid exhibit a nonzero electrophoretic mobility in an aqueous standard potassium chloride solution at a pH which corresponds to the pH of the aqueous dispersion medium before the beginning of dispersant addition,
c) at least one anionic, cationic and nonionic dispersant is added to the aqueous solid-particle dispersion before the beginning of the addition of said at least one ethylenically unsaturated monomer,
d) then from 0.01 to 30% by weight of the total amount of said at least one monomer are added to the aqueous solid-particle dispersion and polymerized to a conversion of at least 90%,
   and
e) thereafter the remainder of said at least one monomer is added under polymerization conditions continuously at the rate at which it is consumed.

The process of the invention is likewise advantageously suitable for aqueous composite-particle dispersions of the kind prepared by a procedure which is disclosed in a priority-substantiating European patent application filed by the applicant, having application no. 09157984.7 and to which express reference is made in the context of this specification. This process is distinguished in that at least one ethylenically unsaturated monomer is dispersely distributed in an aqueous medium and is polymerized by the method of free-radical aqueous emulsion polymerization by means of at least one free-radical polymerization initiator in the presence of at least one dispersely distributed, finely divided inorganic solid and at least one dispersely distributed, finely divided inorganic solid and at least one dispersing assistant, where
a) 1% to 1000% by weight of an inorganic solid having an average particle size≦100 nm and 0.05% to 2% by weight of a free-radical polymerization initiator are used, based on the total amount of ethylenically unsaturated monomers (total monomer amount),
b) at least one portion of the inorganic solid is introduced in an aqueous polymerization medium in the form of an aqueous dispersion of solid, after which
c) metered into the resulting aqueous dispersion of solid is a total of ≧0.01% and ≦20% by weight of the total monomer amount and ≧60% by weight of the total monomer amount of free-radical polymerization initiator, and the ethylenically unsaturated monomers metered in are polymerized under polymerization conditions to a monomer conversion≧80% by weight (polymerization stage 1), and subsequently
d) any remainder of the inorganic solid, any remainder of the free-radical polymerization initiator, and the remainder of the ethylenically unsaturated monomers are metered into the resulting polymerization mixture under polymerization conditions and are polymerized to a monomer conversion≧90% by weight (polymerization stage 2).

Finely divided inorganic solids suitable for the process disclosed in WO 03000760 are all those which form stable aqueous dispersions which at an initial solids concentration of ≧1% by weight, based on the aqueous dispersion of said at least one inorganic solid, still comprise in dispersed form one hour after their preparation without stirring or shaking more than 90% by weight of the originally dispersed solid and whose dispersed solid particles have a diameter≦100 nm and which, furthermore, exhibit a nonzero electrophoretic mobility at a pH which corresponds to the pH of the aqueous reaction medium before the beginning of dispersant addition.

The quantitative determination of the initial solids concentration and the solids concentration after one hour, and the determination of the particle diameters, take place by the method of analytical ultracentrifugation (cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell AUC Multiplexer: High Resolution Particle Size Distribution and Density Gradient Techniques, W. Mächtle, pages 147 to 175). The particle diameters stated are those known as d₅₀ values.

The method of determining the electrophoretic mobility is known to the skilled worker (cf., e.g., R. J. Hunter, Introduction to Modern Colloid Science, Section 8.4, pages 241 to 248, Oxford University Press, Oxford, 1993, and K. Oka and K. Furusawa in Electrical Phenomena at Interfaces, Surfactant Science Series, Vol. 76, Chapter 8, pages 151 to 232, Marcel Dekker, New York, 1998). The electrophoretic mobility of the solid particles dispersed in the aqueous reaction medium is measured using a commercial electrophoresis instrument, an example being the Zetasizer 3000 from Malvern Instruments Ltd., at 20° C. and 1 bar (absolute). For this purpose the aqueous dispersion of solid particles is diluted with a pH-neutral 10 millimolar (mM) aqueous potassium chloride solution (standard potassium chloride solution) until the concentration of solid particles is from about 50 to 100 mg/l. The adjustment of the sample to the pH possessed by the aqueous reaction medium before the beginning of dispersant addition is carried out using the customary inorganic acids, such as dilute hydrochloric acid or nitric acid, for example, or bases, such as dilute sodium hydroxide solution or potassium hydroxide solution, for example. The migration of the dispersed solid particles in the electrical field is detected by means of what is known as electrophoretic light scattering (cf., e.g., B. R. Ware and W. H. Flygare, Chem. Phys. Lett. 12 (1971) 81 to 85). In this method the sign of the electrophoretic mobility is defined by the migrational direction of the dispersed solid particles; in other words, if the dispersed solid particles migrate to the cathode, their electrophoretic mobility is positive, while if they migrate to the anode it is negative.

A suitable parameter for influencing or adjusting the electrophoretic mobility of dispersed solid particles to a certain extent is the pH of the aqueous reaction medium. Protonation and, respectively, deprotonation of the dispersed solid particles alter the electrophoretic mobility positively in the acidic pH range (pH<7) and negatively in the alkaline range (pH>7). A pH range suitable for the process disclosed in WO 03000760 is that within which a free-radically initiated aqueous emulsion polymerization can be carried out. This pH range is generally from 1 to 12, frequently from 1.5 to 11, and often from 2 to 10.

The pH of the aqueous reaction medium may be adjusted using commercially customary acids, such as dilute hydrochloric, nitric or sulfuric acid, or bases, such as dilute sodium hydroxide or potassium hydroxide solution, for example. It is often advantageous to add some or all of the quantity of acid or base used for pH adjustment to the aqueous reaction medium before said at least one finely divided inorganic solid is added.

It is of advantage for the process disclosed in WO 03000760 if under the abovementioned pH conditions
when the dispersed solid particles have an electrophoretic mobility having a negative sign, per 100 parts by weight of said at least one ethylenically unsaturated monomer, from 0.01 to 10 parts by weight, preferably from 0.05 to 5 parts by weight, and with particular preference from 0.1 to 3 parts by weight, of at least one cationic dispersant, from 0.01 to 100 parts by weight, preferably from 0.05 to 50 parts by weight, and with particular preference from 0.1 to 20 parts by weight, of at least one nonionic dispersant, and at least one anionic dispersant are used, the amount thereof being such that the equivalent ratio of anionic to cationic dispersant is more than 1, or
when the dispersed solid particles have an electrophoretic mobility having a positive sign, per 100 parts by weight of said at least one ethylenically unsaturated monomer, from 0.01 to 10 parts by weight, preferably from 0.05 to 5 parts by weight, and with particular preference from 0.1 to 3 parts by weight, of at least one anionic dispersant, from 0.01 to 100 parts by weight, preferably from 0.05 to 50 parts by weight, and with particular preference from 0.1 to 20 parts by weight, of at least one nonionic dispersant, and at least one cationic dispersant are used, the amount thereof being such that the equivalent ratio of cationic to anionic dispersant is more than 1.

The equivalent ratio of anionic to cationic dispersant means the number of moles of the anionic dispersant used multiplied by the number of anionic groups present per mole of the anionic dispersant, divided by the number of moles of the cationic dispersant used multiplied by the number of the cationic groups present per mole of the cationic dispersant. The equivalent ratio of cationic to anionic dispersant is defined accordingly.

The total amount of said at least one anionic, cationic and nonionic dispersant used in accordance with WO 03000760 may be included in the initial charge in the aqueous dispersion of solids. It is, however, also possible to include only some of said dispersants in the initial charge in the aqueous dispersion of solids and to add the remainders continuously or discontinuously during the free-radical emulsion polymerization. It is, however, essential to the invention that, before and during the free-radically initiated emulsion polymerization, the abovementioned equivalent ratio of anionic and cationic dispersant as a function of the electrophoretic sign of the finely divided solid is maintained. When, therefore, inorganic solid particles are used which under the aforementioned pH conditions have an electrophoretic mobility having a negative sign, the equivalent ratio of anionic to cationic dispersant must be greater than 1 throughout the emulsion polymerization. Similarly, in the case of inorganic solid particles having an electrophoretic mobility having a positive sign, the equivalent ratio of cationic to anionic dispersant must be greater than 1 throughout the emulsion polymerization. It is advantageous if the equivalent ratios are ≧2, ≧3, ≧4, ≧5, ≧6, ≧7, or ≧10, with equivalent ratios in the range between 2 and 5 being particularly advantageous.

Suitable finely divided inorganic solids which can be used for the two above-mentioned explicitly disclosed processes and generally for preparing composite particles include metals, metal compounds, such as metal oxides and metal salts, and also semimetal compounds and nonmetal compounds. Finely divided metal powders which can be used are noble metal colloids, such as palladium, silver, ruthenium, platinum, gold and rhodium, for example, and their alloys. Examples that may be mentioned of finely divided metal oxides include titanium dioxide (commercially available, for example, as Hombitec® grades from Sachtleben Chemie GmbH), zirconium(IV) oxide, tin(II) oxide, tin(IV) oxide (commercially available, for example, as Nyacol® SN grades from Nyacol Nano Technologies Inc.), aluminum oxide (commercially available, for example, as Nyacol® AL grades from Nyacol Nano Technologies Inc.), barium oxide, magnesium oxide, various iron oxides, such as iron(II) oxide (wuestite), iron(III) oxide (hematite) and iron(II/III) oxide (magnetite), chromium(III) oxide, antimony(III) oxide, bismuth(III) oxide, zinc oxide (commercially available, for example, as Sachtotec® grades from Sachtleben Chemie GmbH), nickel(II) oxide, nickel(III) oxide, cobalt(II) oxide, cobalt(III) oxide, copper(II) oxide, yttrium(III) oxide (commercially available, for example, as Nyacol® YTTRIA grades from Nyacol Nano Technologies Inc.), cerium(IV) oxide (commercially available, for example, as Nyacol® CEO2 grades from Nyacol Nano Technologies Inc.), amorphous and/or in their different crystal modifications, and also their hydroxy oxides, such as, for example, hydroxytitanium(IV) oxide, hydroxyzirconium(IV) oxide, hydroxyaluminum oxide (commercially available, for example, as Disperal® grades from Sasol GmbH) and hydroxyiron(III) oxide, amorphous and/or in their different crystal modifications. The following metal salts, amorphous and/or in their different crystal structures, can be used in principle in the process of the invention: sulfides, such as iron(II) sulfide, iron(III) sulfide, iron(II) disulfide (pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, and bismuth(III) sulfide, hydroxides, such as tin(II) hydroxide, aluminum hydroxide, magnesium hydroxide, calcium hydroxide, barium hydroxide, zinc hydroxide, iron(II) hydroxide, and iron(III) hydroxide, sulfates, such as calcium sulfate, strontium sulfate, barium sulfate, and lead(IV) sulfate, carbonates, such as lithium carbonate, magnesium carbonate, calcium carbonate, zinc carbonate, zirconium(IV) carbonate, iron(II) carbonate, and iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, and iron(III) orthophosphate, metaphosphates, such as lithium metaphosphate, calcium metaphosphate, and aluminum metaphosphate, pyrophosphates, such as magnesium pyrophosphate, calcium pyrophosphate, zinc pyrophosphate, iron(III) pyrophosphate, and tin(II) pyrophosphate, ammonium phosphates, such as magnesium ammonium phosphate, zinc ammonium phosphate, hydroxyapatite [Ca₅{(PO₄)₃OH}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate and zirconium(IV) orthosilicate, metasilicates, such as lithium metasilicate, calcium/magnesium metasilicate, calcium metasilicate, magnesium metasilicate, and zinc metasilicate, phyllosilicates, such as sodium aluminum silicate and sodium magnesium silicate, especially in spontaneously delaminating form, such as, for example, Optigel® SH (trademark of Rockwood Specialties Inc.), Saponit® SKS-20 and Hektorit® SKS 21 (trademarks of Hoechst AG), and Laponite® RD and Laponite® GS (trademarks of Rockwood Specialties Inc.), aluminates, such as lithium aluminate, calcium aluminate, and zinc aluminate, borates, such as magnesium metaborate and magnesium orthoborate, oxalates, such as calcium oxalate, zirconium(IV) oxalate, magnesium oxalate, zinc oxalate, and aluminum oxalate, tartrates, such as calcium tartrate, acetylacetonates, such as aluminum acetylacetonate and iron(III) acetylacetonate, salicylates, such as aluminum salicylate, citrates, such as calcium citrate, iron(II) citrate, and zinc citrate, palmitates, such as aluminum palmitate, calcium palmitate, and magnesium palmitate, stearates, such as aluminum stearate, calcium stearate, magnesium stearate, and zinc stearate, laurates, such as calcium laurate, linoleates, such as calcium linoleate, and oleates, such as calcium oleate, iron(II) oleate, and zinc oleate.

As an essential semimetal compound which can be used, mention may be made of amorphous silicon dioxide and/or silicon dioxide present in different crystal structures.

Correspondingly suitable silicon dioxide is commercially available and can be obtained, for example, as Aerosil® (trademark of Evonik Industries AG), Levasil® (trademark of H.C. Starck GmbH), Ludox® (trademark of DuPont), Nyacol®, Bindzil® (trademarks of Akzo-Nobel), Nalco (trademark of Nalco Chemical Company) and Snowtex® (trademark of Nissan Chemical Industries, Ltd.). Suitable nonmetal compounds are, for example, colloidal graphite and diamond.

Particularly suitable finely divided inorganic solids are those whose solubility in water at 20° C. and ≦1 bar (absolute) is ≦1 g/l, preferably ≦0.1 g/l and, in particular, ≦0.01 g/l. Particular preference is given to compounds selected from the group consisting of silicon dioxide, aluminum oxide, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphosphate, magnesium metaphosphate, calcium pyrophosphate, magnesium pyrophosphate, orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, phyllosilicates, such as sodium aluminum silicate and sodium magnesium silicate, especially in spontaneously delaminating form, such as Optigel® SH, Saponit® SKS-20 and Hektorit® SKS 21, for example, and also Laponite® RD and Laponite® GS, iron(II) oxide, iron(III) oxide, iron(II/III) oxide, titanium dioxide, hydroxylapatite, zinc oxide, and zinc sulfide. Particular preference is given to silicon compounds, such as pyrogenic and/or colloidal silica, silicon dioxide sols and/or phyllosilicates. Frequently the silicon compounds have an electrophoretic mobility having a negative sign.

In the abovementioned processes and in general for the preparation of aqueous composite-particle dispersions it is also possible to use with advantage the commercially available compounds of the Aerosil®, Levasil®, Ludox®, Nyacol® and Bindzil® grades (silicon dioxide), Disperal® grades (hydroxyaluminum oxide), Nyacol® AL grades (aluminum oxide), Hombitec® grades (titanium dioxide), Nyacol® SN grades (tin(IV) oxide), Nyacol® YTTRIA grades (yttrium(III) oxide), Nyacol® CEO2 grades (cerium(IV) oxide) and Sachtotec® grades (zinc oxide).

The finely divided inorganic solids which can be used to prepare the composite particles have particles which, dispersed in the aqueous reaction medium, have a particle diameter of ≦100 nm. Finely divided inorganic solids used successfully are those whose dispersed particles have a diameter>0 nm but ≦90 nm, ≦80 nm, ≦70 nm, ≦60 nm, ≦50 nm, ≦40 nm, ≦30 nm, ≦20 nm or ≦10 nm and all values in between. With advantage, finely divided inorganic solids are used which have a particle diameter≦50 nm. The particle diameters are determined by the AUC method.

The obtainability of finely divided solids is known in principle to the skilled worker and they are obtained, for example, by precipitation reactions or chemical reactions in the gas phase (cf. E. Matijevic, Chem. Mater. 5 (1993) 412 to 426; Ullmann's Encyclopedia of Industrial Chemistry, Vol. A 23, pages 583 to 660, Verlag Chemie, Weinheim, 1992; D. F. Evans, H. Wennerström in The Colloidal Domain, pages 363 to 405, Verlag Chemie, Weinheim, 1994, and R. J. Hunter in Foundations of Colloid Science, Vol. I, pages 10 to 17, Clarendon Press, Oxford, 1991).

The stable dispersion of solids is often prepared directly during synthesis of the finely divided inorganic solids in aqueous medium or else by dispersing the finely divided inorganic solid into the aqueous medium. Depending on the way in which said solids are prepared, this is done either directly, in the case, for example, of precipitated or pyrogenic silicon dioxide, aluminum oxide, etc., or by using appropriate auxiliary devices, such as dispersers or ultrasound sonotrodes, for example.

Advantageously for the preparation of the aqueous composite-particle dispersions according to the two abovementioned explicitly disclosed processes, suitable finely divided inorganic solids are those whose aqueous solids dispersion, at an initial solids concentration of ≧1% by weight, based on the aqueous dispersion of said solid, still comprises in dispersed form one hour after its preparation or by stirring or shaking up the sedimented solids, without further stirring or shaking, more than 90% by weight of the originally dispersed solid and whose dispersed solid particles have a diameter≦100 mm. Initial solids concentrations≦60% by weight are customary. With advantage, however, it is also possible to use initial solids concentrations≦55% by weight, ≦50% by weight, ≦45% by weight, ≦40% by weight, ≦35% by weight, ≦30% by weight, ≦25% by weight, ≦20% by weight, ≦15% by weight, ≦10% by weight and ≧2% by weight, ≧3% by weight, ≧4% by weight or ≧5% by weight, based in each case on the aqueous dispersion of the finely divided inorganic solid, and all values in between. In preparing aqueous composite-particle dispersions, per 100 parts by weight of said at least one ethylenically unsaturated monomer, use is made frequently of from 1 to 1000, generally from 5 to 300, and often from 10 to 200 parts by weight of said at least one finely divided inorganic solid.

In preparing the two abovementioned explicitly disclosed aqueous composite-particle dispersions, dispersants used include those which maintain not only the finely divided inorganic solid particles but also the monomer droplets and the resulting composite particles in disperse distribution in the aqueous phase and so ensure the stability of the aqueous dispersions of composite particles that are produced. Suitable dispersants include both the protective colloids commonly used to carry out free-radical aqueous emulsion polymerizations, and emulsifiers.

An exhaustive description of suitable protective colloids is given in Houben-Weyl, Methoden der organischen Chemie, Volume XIV/1, Makromolekulare Stoffe [Macromolecular compounds], Georg-Thieme-Verlag, Stuttgart, 1961, pages 411 to 420.

Examples of suitable neutral protective colloids are polyvinyl alcohols, polyalkylene glycols, cellulose derivatives, starch derivatives and gelatin derivatives.

Suitable anionic protective colloids, i.e., protective colloids whose dispersive component has at least one negative electrical charge, are for example polyacrylic acids and polymethacrylic acids and their alkali metal salts, copolymers comprising acrylic acid, methacrylic acid, 2-acrylamido-2-methylpropanesulfonic acid, 4-styrene-sulfonic acid and/or maleic anhydride, and the alkali metal salts of such copolymers, and also alkali metal salts of sulfonic acids of high molecular mass compounds such as, for example, polystyrene.

Suitable cationic protective colloids, i.e., protective colloids whose dispersive component has at least one positive electrical charge, are, for example, the N-protonated and/or N-alkylated derivatives of homopolymers and copolymers comprising N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-functional acrylates, methacrylates, acrylamides and/or methacrylamides.

It is of course also possible to use mixtures of emulsifiers and/or protective colloids. As dispersants it is common to use exclusively emulsifiers, whose relative molecular weights, unlike those of the protective colloids, are usually below 1500. Where mixtures of surface-active substances are used the individual components must of course be compatible with one another, which in case of doubt can be checked by means of a few preliminary experiments. An overview of suitable emulsifiers is given in Houben-Weyl, Methoden der organischen Chemie, Volume XIV/1, Makromolekulare Stoffe [Macromolecular compounds], Georg-Thieme-Verlag, Stuttgart, 1961, pages 192 to 208.

Customary nonionic emulsifiers are for example ethoxylated mono-, di- and tri-alkylphenols (EO units: 3 to 50, alkyl: C₄ to C₁₂) and ethoxylated fatty alcohols (EO units: 3 to 80; alkyl: C₈ to C₃₆). Examples thereof are the Lutensol® A grades (C₁₂C₁₄ fatty alcohol ethoxylates, EO units: 3 to 8), Lutensol® AO grades (C₁₃C₁₅ oxo alcohol ethoxylates, EO units: 3 to 30), Lutensol® AT grades (C₁₆C₁₈ fatty alcohol ethoxylates, EO units: 11 to 80), Lutensol® ON grades (C₁₀ oxo alcohol ethoxylates, EO units: 3 to 11), and the Lutensol® TO grades (C₁₃ oxo alcohol ethoxylates, EO units: 3 to 20) from BASF AG.

Customary anionic emulsifiers are, for example, alkali metal salts and ammonium salts of alkyl sulfates (alkyl: C₈ to C₁₂), of sulfuric monoesters with ethoxylated alkanols (EO units: 4 to 30, alkyl: C₁₂ to C₁₈) and with ethoxylated alkylphenols (EO units: 3 to 50, alkyl: C₄ to C₁₂), of alkylsulfonic acids (alkyl: C₁₂ to C₁₈) and of alkylarylsulfonic acids (alkyl: C₉ to C₁₈).

Compounds which have proven suitable as further anionic emulsifiers are, furthermore, compounds of the general formula II

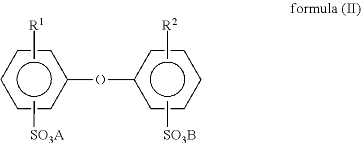

in which R¹ and R² are hydrogens or C₄ to C₂₄ alkyl but are not both simultaneously hydrogens and A and B can be alkali metal ions and/or ammonium ions. In the general formula I, R¹ and R² are preferably linear or branched alkyl radicals of 6 to 18 carbons, especially 6, 12 and 16 carbons, or —H, R¹ and R² not both being hydrogens simultaneously. A and B are preferably sodium, potassium or ammonium, particular preference being given to sodium. Particularly advantageous compounds I are those in which A and B are sodium, R¹ is a branched alkyl radical of 12 carbons, and R² is a hydrogen or R¹. Frequently, use is made of technical-grade mixtures containing a fraction of from 50 to 90% by weight of the monoalkylated product; for example, Dowfax® 2A1 (trademark of Dow Chemical Company). The compounds I are widely known, from U.S. Pat. No. 4,269,749, for example, and are obtainable commercially.

Suitable cation-active emulsifiers are generally C₆-C₁₈ alkyl-, aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts, and salts of amine oxides, quinolinium salts, isoquinolinium salts, tropylium salts, sulfonium salts, and phosphonium salts. Examples that may be mentioned include dodecylammonium acetate or the corresponding hydrochloride, the chlorides and acetates of the various paraffinic acid 2-(N,N,N-trimethylammonium ethyl esters, N-cetylpyridinium chloride, N-laurylpyridinium sulfate, and also N-cetyl-N,N,N-trimethylammonium bromide, N-dodecyl-N,N,N-trimethylammonium bromide, N-octyl-N,N,N-trimethylammonium bromide, N,N-distearyldimethylammonium chloride, and the gemini surfactant N,N′-(lauryldimethyl)ethylenediamine dibromide. Many further examples can be found in H. Stache, Tensid-Taschenbuch, Carl-Hanser-Verlag, Munich, Vienna, 1981, and in McCutcheon's, Emulsifiers & Detergents, MC Publishing Company, Glen Rock, 1989.

Frequently the aqueous composite-particle dispersions are prepared using between 0.1 to 10% by weight, often 0.5 to 7.0% by weight and frequently 1.0 to 5.0% by weight of dispersant(s), based in each case on the total amount of aqueous composite-particle dispersion. Preference is given to using emulsifiers.

Monomers which are ethylenically unsaturated and suitable for preparing the composite particles include, in particular, monomers which are easy to polymerize free-radically, such as, for example, ethylene, vinylaromatic monomers, such as styrene, α-methylstyrene, o-chlorostyrene or vinyltoluenes, esters of vinyl alcohol and C₁-C₁₈ monocarboxylic acids, such as vinyl acetate, vinyl propionate, vinyl n-butyrate, vinyl laurate and vinyl stearate, esters of preferably C₃-C₆ α,β-monoethylenically unsaturated mono- and dicarboxylic acids, such as especially acrylic acid, methacrylic acid, maleic acid, fumaric acid and itaconic acid, with generally C₁-C₁₂, preferably C₁-C₈ and, in particular, C₁-C₄ alkanols, such as, in particular, methyl, ethyl, n-butyl, isobutyl and 2-ethylhexyl acrylate and methacrylate, dimethyl maleate or di-n-butyl maleate, nitriles of α,β-monoethylenically unsaturated carboxylic acids, such as acrylonitrile, and C₄₋₈ conjugated dienes, such as 1,3-butadiene and isoprene. These monomers generally constitute the principal monomers, which, based on the overall amount of the monomers to be polymerized by the process of the invention, normally account for a proportion of ≧50%, ≧80% or ≧90% by weight. As a general rule, these monomers are only of moderate to poor solubility in water under standard conditions [20° C., 1 atm=1.013 bar absolute].

Monomers which customarily increase the internal strength of the films of the polymer matrix normally contain at least one epoxy, hydroxyl, N-methylol or carbonyl group or at least two nonconjugated ethylenically unsaturated double bonds. Examples thereof are monomers having two vinyl radicals, monomers having two vinylidene radicals, and monomers having two alkenyl radicals. Particularly advantageous in this context are the diesters of dihydric alcohols with α,β-monoethylenically unsaturated monocarboxylic acids, among which acrylic and methacrylic acid are preferred. Examples of this kind of monomer having two nonconjugated ethylenically unsaturated double bonds are alkylene glycol diacrylates and dimethacrylates such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, and triallyl isocyanurate. Of particular importance in this context are the methacrylic and acrylic C₁-C₈ hydroxyalkyl esters, such as n-hydroxyethyl, n-hydroxypropyl or n-hydroxybutyl acrylate and methacrylate, and compounds such as diacetoneacrylamide and acetylacetoxyethyl acrylate and methacrylate. Examples of epoxy-containing monomers are glycidyl acrylate and methacrylate. In accordance with the invention, the abovementioned monomers are copolymerized in amounts of up to 5% by weight, based on the total amount of the monomers to be polymerized.

Frequently it may be advantageous, in addition to the aforementioned monomers, to make use, additionally, of ethylenically unsaturated monomers which contain at least one silicon-containing functional group (silane monomers), such as, for example, vinylalkoxysilanes, especially vinyltrimethoxysilane, vinyltriethoxysilane, vinyltriiso-propoxysilane, vinyltriphenoxysilane, vinyltris(dimethylsiloxy)silane, vinyltris(2-methoxyethoxy)silane, vinyltris(3-methoxypropoxy)silane and/or vinyltris(trimethyl-siloxy)silane, acryloyloxysilanes, especially 2-(acryloyloxyethoxy)trimethylsilane, acryloyloxymethyltrimethylsilane, (3-acryloyloxypropyl)dimethylmethoxysilane, (3-acryloyloxypropyl)methylbis(trimethylsiloxy)silane, (3-acryloyloxypropyl)methyl-dimethoxysilane, (3-acryloyloxypropyl)trimethoxysilane and/or (3-acryloyloxypropyl)tris-(trimethylsiloxy)silane, methacryloyloxysilanes, especially (3-methacryloyloxypropyl)trimethoxysilane, (3-methacryloyloxypropyl)methyldimethoxy-silane, (3-methacryloyloxypropyl)dimethylmethoxysilane, (3-methacryloyloxypropyl)-triethoxysilane, (methacryloyloxymethyl)methyldiethoxysilane and/or (3-methacryloyl-oxypropyl)methyldiethyloxysilane. Particularly advantageous in accordance with the invention are acrylolyoxysilanes and/or methacryloyloxysilanes, particularly methacryloyloxysilanes, such as preferably (3-methacryloyloxypropyl)trimethoxysilane, (3-methacryloyloxypropyl)methyldimethoxysilane, (3-methacryloyloxypropyl)dimethyl-methoxysilane, (3-methacryloyloxypropyl)triethoxysilan, (methacryloyloxymethyl)-methyldiethoxysilane and/or (3-methacryloyloxypropyl)methyldiethoxysilane. The amount of silane monomers is ≧0.01 and ≦10%, advantageously ≧0.1 and ≦5%, and with particular advantage ≧0.1 and ≦2%, by weight, based in each case on the total monomer amount.

Besides these, it is possible additionally to use as monomers those ethylenically unsaturated monomers X (\hat{=}monomers A in WO 03000760) which comprise either at least one acid group and/or its corresponding anion or those ethylenically unsaturated monomers Y (\hat{=}monomers B in WO 03000760) which comprise at least one amino, amido, ureido or N-heterocyclic group and/or the N-protonated or N-alkylated ammonium derivatives thereof. Based on the total monomer amount, the amount of monomers X or monomers Y, respectively, is up to 10% by weight, often from 0.1 to 7% by weight, and frequently from 0.2 to 5% by weight.

Monomers X used are ethylenically unsaturated monomers containing at least one acid group. The acid group may, for example, be a carboxylic, sulfonic, sulfuric, phosphoric and/or phosphonic acid group. Examples of monomers X are acrylic acid, methacrylic acid, maleic acid, fumaric acid, itaconic acid, crotonic acid, 4-styrenesulfonic acid, 2-methacryloyloxyethylsulfonic acid, vinylsulfonic acid, and vinylphosphonic acid, and also phosphoric monoesters of n-hydroxyalkyl acrylates and n-hydroxyalkyl methacrylates, such as phosphoric monoesters of hydroxyethyl acrylate, n-hydroxy-propyl acrylate, n-hydroxybutyl acrylate and hydroxyethyl methacrylate, n-hydroxy-propyl methacrylate or n-hydroxybutyl methacrylate, for example. In accordance with the invention, however, it is also possible to use the ammonium and alkali metal salts of the aforementioned ethylenically unsaturated monomers containing at least one acid group. Particularly preferred alkali metals are sodium and potassium. Examples of such compounds are the ammonium, sodium, and potassium salts of acrylic acid, methacrylic acid, maleic acid, fumaric acid, itaconic acid, crotonic acid, 4-styrene-sulfonic acid, 2-methacryloyloxyethylsulfonic acid, vinylsulfonic acid, and vinyl-phosphonic acid, and also the mono- and di-ammonium, -sodium and -potassium salts of the phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Preference is given to using acrylic acid, methacrylic acid, maleic acid, fumaric acid, itaconic acid, crotonic acid, 4-styrenesulfonic acid, 2-methacryloyloxyethylsulfonic acid, vinylsulfonic acid, and vinylphosphonic acid.

As monomers Y, use is made of ethylenically unsaturated monomers which comprise at least one amino, amido, ureido or N-heterocyclic group and/or the N-protonated or N-alkylated ammonium derivatives thereof.

Examples of monomers Y which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methyl-amino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (available commercially, for example, as Norsocryl® TBAEMA from Arkema Inc.), 2-(N,N-dimethylamino)ethyl acrylate (available commercially, for example, as Norsocryl® ADAME from Arkema Inc.), 2-(N,N-dimethylamino)ethyl methacrylate (available commercially, for example, as Norsocryl®MADAME from Arkema Inc.), 2-(N,N-diethylamino)ethyl acrylate, 2-(N,N-diethyl-amino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethyl-amino)propyl methacrylate, 3-(N-n-propylamino)propyl acrylate, 3-(N-n-propyl-amino)propyl methacrylate, 3-(N-isopropylamino)propyl acrylate, 3-(N-isopropyl-amino)propyl methacrylate, 3-(N-tert-butylamino)propyl acrylate, 3-(N-tert-butyl-amino)propyl methacrylate, 3-(N,N-dimethylamino)propyl acrylate, 3-(N,N-dimethyl-amino)propyl methacrylate, 3-(N,N-diethylamino)propyl acrylate, 3-(N,N-diethyl-amino)propyl methacrylate, 3-(N,N-di-n-propylamino)propyl acrylate, 3-(N,N-di-n-propylamino)propyl methacrylate, 3-(N,N-diisopropylamino)propyl acrylate and 3-(N,N-diisopropylamino)propyl methacrylate.

Examples of monomers Y which comprise at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-diisopropylacrylamide, N,N-diisopropyl-methacrylamide, N,N-di-n-butylacrylamide, N,N-di-n-butylmethacrylamide, N-(3-N′,N′-dimethylaminopropyl)methacrylamide, diacetoneacrylamide, N,N′-methylenebisacrylamide, N-(diphenylmethyl)acrylamide, N-cyclohexylacrylamide, and also N-vinylpyrrolidone and N-vinylcaprolactam.

Examples of monomers Y which comprise at least one ureido group are N,N′-divinylethyleneurea and 2-(1-imidazolin-2-onyl)ethyl methacrylate (available commercially, for example, as Norsocryl® 100 from Arkema Inc.).

Examples of monomers Y which comprise at least one N-heterocyclic group are 2-vinylpyridine, 4-vinylpyridine, 1-vinylimidazole, 2-vinylimidazole, and N-vinyl-carbazole.

Preference is given to using the following compounds: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate.

Depending on the pH of the aqueous reaction medium, it is also possible for some or all of the aforementioned nitrogen-containing monomers Y to be present in the N-protonated quaternary ammonium form.

Examples that may be mentioned of monomers Y which have a quaternary alkylammonium structure on the nitrogen include 2-(N,N,N-trimethylammonium)ethyl acrylate chloride (available commercially, for example, as Norsocryl® ADAMQUAT MC 80 from Arkema Inc.), 2-(N,N,N-trimethylammonium)ethyl methacrylate chloride (available commercially, for example, as Norsocryl® MADQUAT MC 75 from Arkema Inc.), 2-(N-methyl-N,N-diethylammonium)ethyl acrylate chloride, 2-(N-methyl-N,N-diethylammonium)ethyl methacrylate chloride, 2-(N-methyl-N,N-dipropylammonium)ethyl acrylate chloride, 2-(N-methyl-N,N-dipropylammonium)ethyl methacrylate, 2-(N-benzyl-N,N-dimethylammonium)ethyl acrylate chloride (available commercially, for example, as Norsocryl® ADAMQUAT BZ 80 from Arkema Inc.), 2-(N-benzyl-N,N-dimethylammonium)ethyl methacrylate chloride (available commercially, for example, as Norsocryl® MADQUAT BZ 75 from Arkema Inc.), 2-(N-benzyl-N,N-diethylammonium)ethyl acrylate chloride, 2-(N-benzyl-N,N-diethyl-ammonium)ethyl methacrylate chloride, 2-(N-benzyl-N,N-dipropylammonium)ethyl acrylate chloride, 2-(N-benzyl-N,N-dipropylammonium)ethyl methacrylate chloride, 3-(N,N,N-trimethylammonium)propyl acrylate chloride, 3-(N,N,N-trimethyl-ammonium)propyl methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropylammonium)propyl acrylate chloride, 3-(N-methyl-N,N-dipropylammonium)propyl methacrylate chloride, 3-(N-benzyl-N,N-dimethyl-ammonium)propyl acrylate chloride, 3-(N-benzyl-N,N-dimethylammonium)propyl methacrylate chloride, 3-(N-benzyl-N,N-diethylammonium)propyl acrylate chloride, 3-(N-benzyl-N,N-diethylammonium)propyl methacrylate chloride, 3-(N-benzyl-N,N-dipropylammonium)propyl acrylate chloride, and 3-(N-benzyl-N,N-dipropyl-ammonium)propyl methacrylate chloride. It is of course also possible to use the corresponding bromides and sulfates instead of the chlorides named.

Preference is given to using 2-(N,N,N-trimethylammonium)ethyl acrylate chloride, 2-(N,N,N-trimethylammonium)ethyl methacrylate chloride, 2-(N-benzyl-N,N-dimethyl-ammonium)ethyl acrylate chloride, and 2-(N-benzyl-N,N-dimethylammonium)ethyl methacrylate chloride.

It is of course also possible to use mixtures of the aforementioned ethylenically unsaturated monomers.

Initiators suitable for initiating the free-radical polymerization are all those polymerization initiators (free-radical initiators) capable of triggering a free-radical aqueous emulsion polymerization. The initiators can in principle comprise both peroxides and azo compounds. Redox initiator systems are also suitable, of course. Peroxides used can in principle be inorganic peroxides, such as hydrogen peroxide or peroxodisulfates, such as the mono- or di-alkali metal salts or ammonium salts of peroxodisulfuric acid, examples being the mono- and di-sodium and -potassium salts, or ammonium salts, or else organic peroxides, such as alkyl hydroperoxides, examples being tert-butyl, p-menthyl and cumyl hydroperoxide, and also dialkyl or diaryl peroxides, such as di-tert-butyl peroxide or dicumyl peroxide. Azo compounds used are primarily 2,2′-azobis(isobutyronitrile), 2,2′-azobis(2,4-dimethylvaleronitrile) and 2,2′-azobis(amidinopropyl)dihydrochloride (AIBA, corresponding to the commercial product V-50 from Wako Chemicals). Suitable oxidizing agents for redox initiator systems are essentially the abovementioned peroxides. Corresponding reducing agents used can be compounds of sulfur with a low oxidation state, such as alkali metal sulfites, e.g., potassium and/or sodium sulfite, alkali metal hydrogen sulfites, e.g., potassium and/or sodium hydrogen sulfite, alkali metal metabisulfites, e.g., potassium and/or sodium metabisulfite, formaldehyde-sulfoxylates, e.g., potassium and/or sodium formaldehyde-sulfoxylate, alkali metal salts, especially potassium salts and/or sodium salts, of aliphatic sulfinic acids, and alkali metal hydrogen sulfides, e.g., potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid, and reducing saccharides, such as sorbose, glucose, fructose and/or dihydroxyacetone. Where redox initiator systems are used in accordance with the invention, the oxidizing agents and the reducing agents are frequently metered in in parallel or, preferably, the total amount of the corresponding oxidizing agent is included in the initial charge and only the reducing agent is metered in. The total amount of free-radical initiator in the case of redox initiator systems is formed from the total amounts of oxidizing and reducing agents. Free-radical initiators used with preference, however, are inorganic and organic peroxides, and especially inorganic peroxides, frequently in the form of aqueous solutions. Particularly preferred as free-radical initiator are sodium peroxodisulfate, potassium peroxodisulfate, ammonium peroxodisulfate, hydrogen peroxide and/or tert-butyl hydroperoxide.

In accordance with European patent application No. 09157984.7, the amount of free-radical initiator used in total is 0.05% to 2%, advantageously 0.1% to 1.5%, and with particular advantage 0.3% to 1.0%, by weight, based in each case on the total monomer amount. According to the other preparation processes, the amount of free-radical initiator can be up to 5% by weight, based on the total monomer amount.

It is essential to the invention that, in accordance with the teaching of European patent application No. 09157984.7, in stage c) of the process a total of ≧0.01% and ≦20% by weight of the total monomer amount and ≧60%, preferably ≧70%, and also ≦90% or ≦100%, and with particular preference ≧75% and ≦85%, by weight, of the total amount of free-radical polymerization initiator are metered in to the aqueous dispersion of solid, and the ethylenically unsaturated monomers metered in are polymerized under polymerization conditions to a monomer conversion≧80%, preferably ≧85%, with particular preference ≧90%, by weight.

The addition of the free-radical initiator to the aqueous polymerization medium in stage c) of the process of European patent application No. 09157984.7 may be made under polymerization conditions. It is, however, also possible for a portion or the entirety of the free-radical initiator to be added to the aqueous polymerization medium, comprising the monomer introduced in the initial charge, under conditions which are not such as to trigger a polymerization reaction, such as at low temperature, for example, and subsequently to establish polymerization conditions in the aqueous polymerization mixture.

In process stage c), the addition of the free-radical initiator or its components may be made discontinuously in one or more portions or continuously with constant or changing volume flow rates.

The determination of the monomer conversion is familiar in principle to the skilled worker and is accomplished for example by reaction-calorimetric determination.

After the amount of the monomers used have been polymerized to a conversion≧80% by weight in step c) of the process of European patent application No. 09157984.7 (polymerization stage 1), then, in the subsequent step d) of the process, any remainder, i.e., ≦90%, ≦80%, ≦70%, ≦60%, and advantageously ≦50%, ≦40%, ≦30%, ≦20% by weight or ≦10% by weight of the inorganic solid, any remainder, i.e., ≦40%, ≦30% or, preferably, ≧15% and ≦25% by weight of the free-radical polymerization initiator, and the remainder, i.e., ≧80% and ≦99.99%, preferably ≧85% and ≦99%, and with particular preference ≧85% and ≦95%, by weight of the ethylenically unsaturated monomers are metered in under polymerization conditions and polymerized to a monomer conversion≧90% by weight (polymerization stage 2). In this case, in steps c) and d) of the process, the metered addition of the respective components can be metered in as separate individual streams or in a mixture discontinuously in one or more portions or continuously with constant or changing volume flow rates. It will be appreciated that it is also possible for the free-radical initiators or ethylenically unsaturated monomers to differ in steps c) and d) of the process.

Under polymerization conditions means, in the context of this specification, generally those temperatures and pressures under which the free-radically initiated aqueous emulsion polymerization proceeds at a sufficient polymerization rate. These conditions are dependent in particular on the free-radical initiator used. Advantageously the nature and amount of the free-radical initiator, the polymerization temperature, and the polymerization pressure in steps c) and d) of the process are selected such that the free-radical initiator used has a sufficient half-life and there are always sufficient initiating radicals available to trigger and maintain the polymerization reaction.

Suitable reaction temperatures for the free-radical aqueous polymerization reaction in the presence of the finely divided inorganic solid generally embrace the entire range from 0 to 170° C. In general, the temperatures used are ≧50 and ≦120° C., frequently ≧60 and ≦110° C. and often ≧70 and ≦100° C. The free-radical aqueous emulsion polymerization can be conducted at a pressure less than, equal to or greater than 1 atm (absolute), so that the polymerization temperature may exceed 100° C. and can be up to 170° C. Highly volatile monomers such as ethylene, butadiene or vinyl chloride are preferably polymerized under increased pressure. In this case the pressure can adopt values of 1.2, 1.5, 2, 5, 10 or 15 bar or higher. When emulsion polymerizations are conducted under subatmospheric pressure, pressures of 950 mbar, frequently 900 mbar and often 850 mbar (absolute) are established. The free-radical aqueous polymerization is advantageously conducted at 1 atm (absolute) under an inert gas atmosphere, such as under nitrogen or argon, for example.

The aqueous reaction medium may in principle also comprise, to a minority extent, water-soluble organic solvents, such as methanol, ethanol, isopropanol, butanols, pentanols, and also acetone, etc., for example. Preferably, however, the polymerization reaction is conducted in the absence of such solvents.

Besides the abovementioned components, it is also possible, optionally, in the processes for the preparation of the aqueous composite-particle dispersion to use free-radical chain-transfer compounds in order to reduce or control the molecular weight of the polymers obtainable by the polymerization. Suitable compounds of this type include, essentially, aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomers, n-octanethiol and its isomers, n-nonanethiol and its isomers, n-decanethiol and its isomers, n-undecanethiol and its isomers, n-dodecanethiol and its isomers, n-tridecanethiol and its isomers, substituted thiols, such as 2-hydroxyethanethiol, aromatic thiols, such as benzenethiol, ortho-, meta-, or para-methylbenzenethiol, and also all other sulfur compounds described in Polymer Handbook, 3^{rd} Edition, 1989, J. Brandrup and E. H. Immergut, John Wiley & Sons, Section II, pages 133 to 141, and also aliphatic and/or aromatic aldehydes, such as acetaldehyde, propionaldehyde and/or benzaldehyde, unsaturated fatty acids, such as oleic acid, dienes with nonconjugated double bonds, such as divinylmethane, or vinylcyclohexane or hydrocarbons having readily abstractable hydrogen atoms, such as toluene, for example. It is, however, also possible to use mixtures of mutually compatible, abovementioned free-radical chain-transfer compounds. The total amount of the free-radical chain-transfer compounds used optionally, based on the total amount of the monomers to be polymerized, is generally ≦5% by weight, often ≦3% by weight, and frequently ≦1% by weight.

The aqueous dispersions of composite particles that are used in accordance with the invention normally have a total solids content of from 1 to 70% by weight, frequently from 5 to 65% by weight, and often from 10 to 60% by weight.

The composite particles used in accordance with the invention in the form of an aqueous dispersion generally possess average particle diameters of >10 and ≦1000 nm, frequently ≧50 and ≦500 nm and often ≧100 and ≦250 nm. The average particle size of the composite particles is determined by the method of quasielastic light scattering (DIN-ISO 13321).

The composite particles useful in accordance with the invention can have different structures. The composite particles can comprise one or more of the finely divided solid particles. The finely divided solid particles may be completely enveloped by the polymer matrix. Alternatively, it is possible for some of the finely divided solid particles to be enveloped by the polymer matrix while others are arranged on the surface of the polymer matrix. It is of course also possible for a majority of the finely divided solid particles to be bound on the surface of the polymer matrix.

Frequently use is made in particular of composite-particle dispersions whose composite particles are synthesized from addition polymers which are filmable and whose minimum film formation temperature is ≦150° C., preferably ≦100° C. and more preferably ≦50° C. Since at below 0° C. it is no longer possible to measure the minimum film formation temperature, the lower limit of the minimum film formation temperature can be indicated only by means of the glass transition temperature. Frequently the minimum film formation temperature or the glass transition temperature is ≧−50° C. or ≦−30° C. and often ≧−10° C. Advantageously the minimum film formation temperature or the glass transition temperature is in the range ≧−40° C. and ≦100° C., preferably in the range ≧−30° C. and ≦50° C., and more preferably in the range ≧−30° C. and ≦20° C. The minimum film formation temperature is determined in accordance with DIN 53 787 or ISO 2115 and the glass transition temperature by DIN 53 765 (Differential Scanning calorimetry, 20 K/min, midpoint measurement).

The aqueous composite-particle dispersions obtainable by the process of the invention have a markedly higher storage stability than the aqueous composite-particle dispersions which do not comprise any silane compound I.

The dispersions of composite particles of the invention are especially suitable for preparing aqueous formulations, and also as raw materials for preparing adhesives, such as pressure-sensitive adhesives, building adhesives or industrial adhesives, for example, binders, such as for paper coating, for example, emulsion paints, or for printing inks and print varnishes for printing plastics films, for producing nonwovens, and for producing protective coats and water vapor barriers, such as in priming, for example. In addition, the dispersions of composite particles obtainable by the process of the invention can be used to modify cement formulations and mortar formulations. The aqueous composite-particle dispersions obtainable by the process of the invention can also be used, in principle, in medical diagnostics and in other medical applications (cf., e.g., K. Mosbach and L. Andersson, Nature 270 (1977) 259 to 261; P. L. Kronick, Science 200 (1978) 1074 to 1076; and U.S. Pat. No. 4,157,323). With advantage the composite-particle dispersions of the invention are suitable for preparing aqueous coating compositions, such as emulsion paints, inks or primers, for example.

It is significant that the aqueous formulations which, in addition to an aqueous composite-particle dispersion and also at least one silane compound I, also comprise further formulation ingredients, such as dispersants, biocides, thickeners, antifoams, pigments and/or fillers, for example, likewise have a distinctly increased storage stability and so can be processed reliably even after a prolonged period of time, which is why a silane compound I can also be used for improving the storage stability of an aqueous formulation comprising an aqueous composite-particle dispersion.

Accordingly, one advantageous embodiment of this invention as well is a method of improving the storage stability of an aqueous formulation which comprises an aqueous composite-particle dispersion, the method comprising the addition to the aqueous formulation medium, before, during and/or after the addition of the aqueous composite-particle dispersion, of a silane compound I. In this case, in the context of this specification, “before the addition of the aqueous composite-particle dispersion” is intended to mean any desired point in time before the aqueous composite-particle dispersion is added to a mixing apparatus; “during the addition of the aqueous composite-particle dispersion” is intended to mean any desired point in time during the addition of the aqueous composite-particle dispersion to a mixing apparatus; and “after the addition of the aqueous composite-particle dispersion” is intended to mean any desired point in time after the addition of the aqueous composite-particle dispersion to a mixing apparatus in which the aqueous formulation is prepared.

### EXAMPLES

### I. Preparation of the Aqueous Composite-Particle Dispersions

### Composite-Particle Dispersion 1 (CD1)

A 2 l four-necked flask equipped with a reflux condenser, a thermometer, a mechanical stirrer and a metering device was charged under nitrogen atmosphere at from 20 to 25° C. (room temperature) and 1 atm (1.013 bar absolute) and with stirring (200 revolutions per minute) with 416.6 g of Nyacol®2040 and then with a mixture of 2.5 g of methacrylic acid and 12 g of a 10% strength by weight aqueous solution of sodium hydroxide, added over the course of 5 minutes. Thereafter, a mixture of 10.4 g of a 20% strength by weight aqueous solution of the nonionic surfactant Lutensol® AT18 (brand name of BASF SE, C₁₆C₁₈ fatty alcohol ethoxylate having on average 18 ethylene oxide units) and 108.5 g of deionized water were added over the course of 15 minutes to the stirred reaction mixture. Thereafter, 0.83 g of N-cetyl-N,N,N-trimethylammonium bromide (CTAB) in solution in 100 g of deionized water was metered in to the reaction mixture over 60 minutes. The reaction mixture was then heated to a reaction temperature of 80° C.

Prepared in parallel were feed stream 1, a monomer mixture consisting of 117.5 g of methyl methacrylate, 130 g of n-butyl acrylate and 0.5 g of 3-methacryloyloxy-propyltrimethoxysilane, and feed stream 2, an initiator solution consisting of 2.5 g of sodium peroxodisulfate, 7 g of a 10% strength by weight aqueous solution of sodium hydroxide, and 100 g of deionized water.

Subsequently, 21.1 g of feed stream 1 and 57.1 g of feed stream 2 were added to the reaction mixture, stirred at reaction temperature, from two separate feed lines over 5 minutes. The reaction mixture was then stirred at reaction temperature for one hour. Thereafter, 0.92 g of a 45% strength by weight aqueous solution of Dowfax® 2A1 was added to the reaction mixture. The remainders of feed streams 1 and 2 were then metered continuously into the reaction mixture over the course of 2 hours, beginning simultaneously. Thereafter, the reaction mixture was stirred at reaction temperature for one hour more and then cooled to room temperature.

The aqueous composite-particle dispersion thus obtained had a solids content of 41.8% by weight, based on the total weight of the aqueous composite-particle dispersion.

The solids content was determined in general by drying approximately 1 g of the composite-particle dispersion in an open aluminum crucible having an internal diameter of about 3 cm to constant weight in a drying oven at 150° C. For the determination of the solid content, two separate measurements were carried out in each case and the corresponding average was formed.

The particle site of the composite particles was determined generally by the method of quasielastic light scattering (DIN-ISO 13321) using a high performance particle sizer (HPPS) from Malvern Instruments Ltd. An average particle size of 106 nm was found.

### Composite-Particle Dispersion 2 (CD2)

A 2 l four-necked flask equipped with a reflux condenser, a thermometer, a mechanical stirrer and a metering device was charged under nitrogen atmosphere at room temperature and atmospheric pressure and with stirring (200 revolutions per minute) with 416.6 g of Nalco® 1144 (40% by weight colloidal silicon dioxide with an average particle diameter of 14 nm; trademark of Nalco), then 10.8 g of a 20% strength by weight aqueous solution of the nonionic surfactant Lutensol® AT 18, and subsequently 215.0 g of deionized water, over the course of 5 minutes. Subsequently the initial-charge mixture was heated to 70° C.

Prepared in parallel were feed stream 1, a monomer mixture consisting of 12.6 g of methyl methacrylate, 18.8 g of n-butyl acrylate, and 1.5 g of methacrylic acid, feed stream 2, 2.9 g of (3-methacryloyloxypropyl)trimethoxysilane, feed stream 3, an initiator solution consisting of 2.1 g of sodium peroxodisulfate, 5.4 g of a 10% strength by weight aqueous solution of sodium hydroxide, and 93.0 g of deionized water, and feed stream 4, a monomer mixture consisting of 87.3 g of methyl methacrylate and 130.9 g of n-butyl acrylate.

Subsequently the stirred initial-charge mixture was admixed continuously at 70° C. over the course of 90 minutes, via a separate feed line, with 0.9 g of feed stream 2. The reaction mixture was heated to a reaction temperature of 85° C. 45 minutes after the beginning of feed stream 2. An hour after the beginning of feed stream 2, over the course of a period of 120 minutes and via two separate feed lines, beginning simultaneously, the total amount of feed stream 1 and 158.8 g of feed stream 3 were metered in with continuous flow rates. Subsequently, over the course of a period of 120 minutes and by separate feed lines, beginning simultaneously, the total amount of feed stream 4 and the remainder of feed stream 2, and also, over the course of a period of 135 minutes, the remainder of feed stream 3 were metered into the reaction mixture with continuous volume flow rates. Thereafter the aqueous composite-particle dispersion obtained was stirred at reaction temperature for one hour more and then cooled to room temperature.

The aqueous composite-particle dispersion thus obtained was transluscent and of low viscosity and had a solids content of 42.1% by weight. The average particle size of the composite particles was found to be 113 nm.

### II. Storage Stability of the Aqueous Composite-Particle Dispersions

To check the storage stability, the abovementioned composite-particle dispersions CD1 and CD2 were diluted with deionized water to a solids content of 40.0% by weight, in each case 70 g of the diluted composite-particle dispersions was admixed with 0.28 g (corresponding to 0.5% by weight, based on the solids content of the aqueous composite-particle dispersions) and with 0.56 g (corresponding to 1.0% by weight, based on the solids content of the aqueous composite-particle dispersions) of the 50% strength by weight aqueous solutions of the silane compounds I indicated in Table 1, the ingredients were mixed homogeneously, the mixture was then stored in closed 100 ml sample bottles at 70° C. and examined visually each day for gelling (sharp rise in viscosity, “honeylike” viscosity). Table 1 lists the gelling times in days obtained for the different silane compounds I. The experiments were terminated after 60 days.

TABLE 1
Gel times of the aqueous composite-particle dispersions CD1 and CD2
stabilized with silane compounds, in days

| | CD1 | | CD2 | |
|---|---|---|---|---|
| Composite-particle | 0.5% | 1.0% | 0.5% | 1.0% |
| dispersion/silane compound | by weight | by weight | by weight | by weight |
| None | 6 | 6 | 23 | 23 |
| Silane 1¹) | 10 | 16 | 32 | 45 |
| Silane 2²) | 12 | 20 | 41 | >60 |
| Silane 3³) | 21 | 39 | 49 | >60 |
| Silane 4⁴) | 22 | 42 | 55 | >60 |

¹) Silane 1 = 3-[methoxy{tri(ethyleneoxy)}]propyltrimethoxysilane, available from ABCR GmbH & Ko. KG under the order number ABCR SIM6492.7
²) Silane 2 = 3-[methoxy{poly(ethyleneoxy)}]propyltrimethoxysilane, degree of ethoxylation: 6 to 9 ethyleneoxy units, available from ABCR GmbH & Ko. KG under the order number ABCR SIM6492.72
³) Silane 3 = 3-[methoxy{poly(ethyleneoxy)}]propyltrimethoxysilane, degree of ethoxylation: 9 to 12 ethyleneoxy units, available from ABCR GmbH & Ko. KG under the order number ABCR SIM6493.4
⁴) Silane 4 = 3-[methoxy{poly(ethyleneoxy)}]propyltrimethoxysilane, degree of ethoxylation: 12 to 15 ethyleneoxy units, available from Evonik under the brand name Dynasylan ® 4144

1. A process for improving the storage stability of an aqueous dispersion of composite particles, the process comprising adding an organic silane compound of formula (I) to an aqueous dispersion of composite particles, 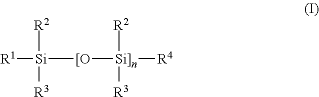
wherein:
R¹ to R³ individually represent C₁-C₁₀ alkoxy, unsubstituted or substituted C₁-C₃₀ alkyl, unsubstituted or substituted C₅-C₁₅ cycloalkyl, unsubstituted or substituted C₆-C₁₀ aryl, or unsubstituted or substituted C₇-C₁₂ aralkyl;
R⁴ is CH₂—[CHR⁵]_{φ}—[O—CH₂CH₂]ₓ—[O—CH₂—CH(CH₃)]_{y}—O—Z;
R⁵ is hydrogen or C₁-C₄ alkyl;
Z is hydrogen or C₁-C₄ alkyl;
n is an integer from 0 to 5;
φ is an integer from 0 to 5;
x is an integer from 1 to 30;
y is an integer from 0 to 30;
at least one of the radicals R¹ to R³ is C₁-C₁₀ alkoxy;
the composite particles comprise an addition polymer and a finely divided inorganic solid; and
the adding of the organic silane occurs during at least one time selected from the group consisting of before, during, and after preparation of the aqueous dispersion of composite particles.

2. The process of claim 1, wherein the adding of the organic silane occurs after the preparation of the aqueous dispersion of composite particles.

3. The process of claim 1, wherein a mixture comprising the aqueous dispersion of composite particles and the organic silane compound has a pH>7 and <11.

4. The process of claim 1, wherein:
R¹ to R³ are methoxy or ethoxy;
R⁵ is hydrogen;
Z is hydrogen or methyl;
n and y are the integer 0;
φ is the integer 2; and
x is [symbol] an integer≧3 and ≦20.

5. The process of claim 1, wherein an amount of the organic silane compound is from 0.01 to 10% by weight, based on a total amount of the aqueous dispersion of composite particles.

6. The process of claim 1, wherein the aqueous dispersion of composite particles is prepared by dispersing at least one ethylenically unsaturated monomer in an aqueous medium and polymerizing a resulting mixture by a method of free-radical aqueous emulsion polymerization with at least one free-radical polymerization initiator in the presence of at least one dispersely distributed, finely divided inorganic solid and at least one dispersant,
wherein:
a) the aqueous dispersion of the at least one inorganic solid is stable, said dispersion having the characteristic features that at an initial solids concentration of ≧1% by weight, based on the stable aqueous dispersion of the at least one inorganic solid, the dispersion still comprises in dispersed form one hour after its preparation more than 90% by weight of an originally dispersed solid and its dispersed solid particles have a weight-average diameter≦100 nm;
b) dispersed particles of the at least one inorganic solid exhibit a nonzero electrophoretic mobility in an aqueous standard potassium chloride solution at a pH corresponding to a pH of the aqueous medium before addition of the dispersant;
c) at least one anionic, cationic and nonionic dispersant is added before adding the at least one ethylenically unsaturated monomer;
d) from 0.01 to 30% by weight of a total amount of the at least one monomer is then added and the resulting mixture is polymerized to a conversion of at least 90%; and
e) a remainder of the at least one monomer is thereafter continuously added under polymerization conditions at a rate at which it is consumed.

7. The process of claim 1, wherein the aqueous dispersion of composite particles is prepared by dispersing at least one ethylenically unsaturated monomer in an aqueous medium and polymerizing a resulting mixture by a method of free-radical aqueous emulsion polymerization with at least one free-radical polymerization initiator in the presence of at least one dispersely distributed, finely divided inorganic solid and at least one dispersing assistant,
wherein:
a) the resulting mixture comprises 1% to 1000% by weight of an inorganic solid having an average particle size≦100 nm and 0.05% to 2% by weight of a free-radical polymerization initiator, based on a total amount of the at least one ethylenically unsaturated monomer;
b) at least one portion of the at least one inorganic solid is introduced in an aqueous polymerization medium in the form of an aqueous dispersion of solid; after which
c) a total of ≧0.01% and ≦20% by weight of a total amount of the at least one monomer and ≧60% by weight of a total monomer amount of the at least one free-radical polymerization initiator are metered into the aqueous dispersion of solid, and the at least one ethylenically unsaturated monomer is polymerized to a monomer conversion≧80% by weight; and subsequently
d) a remainder of the at least one inorganic solid, and a remainder of the at least one free-radical polymerization initiator, and a remainder of the at least one ethylenically unsaturated monomer are metered into a resulting polymerization mixture and are polymerized to a monomer conversion≧90% by weight.

8. The process of claim 1, wherein the finely divided inorganic solid is a silicon compound.

9. The process of claim 8, wherein the finely divided inorganic solid is at least one selected from the group consisting of a pyrogenic, a colloidal silica, and a silicate.

10. The process of claim 1, wherein the organic silane compound is at least one selected from the group consisting of 3-[methoxy-{tri(ethyleneoxy)}]-propyltrimethoxysilane, 3-[methoxy{poly(ethyleneoxy)}]propyltrimethoxysilane with a degree of ethoxylation of 6 to 9, 3-[methoxy{poly(ethyleneoxy)}]propyltrimethoxysilane with a degree of ethoxylation of 9 to 12, and 3-[methoxy{poly(ethyleneoxy)}]propyltrimethoxysilane with a degree of ethoxylation of 12 to 15.

11. An aqueous composite-particle dispersion obtained by the process of claim 1.

12. An aqueous formulation, comprising the aqueous composite-particle dispersion of claim 11 and at least one additional formulating ingredient.

13. An aqueous composite-particle dispersion with improved storage stability, comprising the organic silane compound of claim 1.

14. An aqueous formulation with improved storage stability, comprising the aqueous composite particle dispersion of claim 13 and at least one additional formulating ingredient.

15. A process for improving the storage stability of an aqueous formulation comprising an aqueous dispersion of composite particles, the process comprising adding an organic silane compound of formula (I) to an aqueous formulation medium, 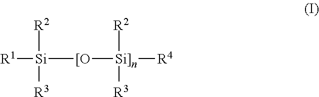
wherein:
R¹ to R³ individually represent C₁-C₁₀ alkoxy, unsubstituted or substituted C₁-C₃₀ alkyl, unsubstituted or substituted C₅-C₁₅ cycloalkyl, unsubstituted or substituted C₆-C₁₀ aryl, or unsubstituted or substituted C₇-C₁₂ aralkyl;
R⁴ is CH₂—[CHR⁵]_{φ}—[O—CH₂CH₂]ₓ—[O—CH₂—CH(CH₃)]_{y}—O—Z;
R⁵ is hydrogen or C₁-C₄ alkyl;
Z is hydrogen or C₁-C₄ alkyl;
n is an integer from 0 to 5;
φ is an integer from 0 to 5;
x is an integer from 1 to 30;
y is an integer from 0 to 30;
at least one of the radicals R¹ to R³ is C₁-C₁₀ alkoxy;
the aqueous formulation comprises an aqueous dispersion of composite particles and at least one additional formulating agent;
the composite particles comprise an addition polymer and a finely divided inorganic solid; and
the adding of the organic silane occurs during at least one time selected from the group consisting of before, during, and after addition of the aqueous dispersion of composite particles to the aqueous formulation medium.
